(19) United States
(12) Patent Application Publication
(10) Pub. No.: US 2004/0097326 A1
(43) Pub. Date: May 20, 2004

(54) Variable ration transmission

(76) Inventor: Malcom Leonard Stephen Dean, Qeensland (AU)

Correspondence Address: YOUNG & THOMPSON, 745 SOUTH 23RD STREET 2ND FLOOR, ARLINGTON, VA, 22202

(21) Appl. No.: 10/471,739

(22) PCT Filed: Mar. 18, 2002
(86) PCT No.: PCT/AU02/00305

(30) Foreign Application Priority Data
Mar. 16, 2001 (AU) PR 3776

(51) Int. Cl. F16H 57/08

(52) U.S. Cl. 475/331

(57) ABSTRACT

A variable ratio transmission having an input (14) and an output (21) and being of the epicyclic type involving a sun element (17, 16)), a ring element (21) and a planet carrier element (22) in each of at least first (11) and second (12) unequal co-axial epicyclic assemblies, a second rotating element (22) of the first assembly (11) and a second rotating element (22) of the second assembly (12) being constrained to rotate at a common angular velocity, and control means (25) for progessively changing the gear ratio applied to a load connected to the first rotating element (21) of the first assembly (11), characterised in that the first rotating elements (21) are unequal pairs of the same mechanical elements of the respective assemblies (11, 12) and in conjunction with respective second rotating elements (22) each represents different respective fixed gear ratios relative to the input (14) and the output (21) of the transmission, the second rotating elements (22) are unequal pairs of the same mechanical elements of the respective assemblies (11, 12) and in conjunction respective said first rotating elements (21), each represents fixed gear ratios between the input (14) and output (21), the control means (23, 25) operable to progressively increase or decrease the output gear ratio as operation demands.

### TECHNICAL FIELD OF THE INVENTION

This invention relates to a variable speed transmission of the epicyclic type.

### BACKGROUND TO THE INVENTION

Epicyclic gear trains, also referred to as planetary gear trains, are those in which one or more gear elements orbit about the central axis of the train. Thus, they differ from an ordinary train by having a moving axis or axes. The trains involve the interaction of three mechanically distinct rotating elements, namely a sun-element, a ring-element and a planet-carrier-element. The planet-carrier-element being a link that mounts one or more planet elements.

Epicyclic gear trains are, fundamentally, two-degree-of-freedom systems. Therefore, two inputs are required before they can be uniquely analysed. Quite frequently a fixed gear is included in the train. Its angular velocity is zero, but this zero value constitutes one of the input values. Any sun-element, ring-element or planet carrier-element can serve as an input or output.

The equation for Power is:

P=T*ω

Where P=Power

T=Torque

ω=angular velocity

The power through any of the rotating elements of the epicyclic gear train therefore is proportional to the torque and angular velocity of the element. Power is conserved through any system meaning that the power into a system equals the power out of that system. Some of the energy transferred through the system may be dissipated or stored as non-useful energy and therefore the useful power output from a system may be different to the power into the system.

If an epicyclic train with one of the degrees-of-freedom constrained from rotating has the resistive torque acting on its output reduced, and the input power remains the same, the speed of the output will increase. The power in equals the power out and assuming that the dissipative power is small relative to the input power, the useful power out will be similar to the power in. The fixed ratio of output to input means that a change of torque at the output means a changed torque requirement at the input. If the input power is constant then if one of either the input torque or angular velocity changes then the other will adjust also. So the input angular velocity increases so that the product of the input torque and angular velocity remains the same. If further the input angular velocity remains constant, then as the resistive torque acting on the output is reduced further, the element constrained from rotation can be released and the power not used at the input can be diverted to that element in such a way that it uses the power to increase its speed and therefore increase the output speed.

An object of the present invention is to use the balancing of power discussed above to provide a variable speed transmission of the epicyclic type as a useful alternative to the prior art.

### OUTLINE OF THE INVENTION

This invention relates to devices for the transmission of mechanical power, in the form of rotational motion. In particular, it is directed to the transmission of power between one or more motive sources and one or more resistive torques (loads) to provide a device which can provide, in a preferred form, continuously variable ratios between the angular velocity at an output to the angular velocity of an input. The continuously variable ratios can be selected manually, or in a preferred form automatically by self-regulating means, and can provide variable output angular velocity and variable torque multiplication.

The present invention finds uses in many applications including electronic, hydraulic and mechanical. Examples of similar drives are Australian patents 607822 and 613927 as spin control differentials for vehicles and couplings. Australian patent 607822 protects the use of a double cam, which enables ratios that would not be practical with the use of a single cam where cycloidal elements are used and the double cam enables balancing. Australian patent 607822 describes the use of certain types of sprag-clutches. The Australian patent 607822 has been assigned to M.L.S. Dean. Eaton Corporation has an Australian Patent number 465202 based on a planetary drive that has a sun gear, a ring gear and a planet carrier. Sumitomo Heavy Industries Ltd, Japan, under the name “Cyclodrive” manufacture examples of planetary drives.

Although planetary gears are known, the known prior art gears have failed to take advantage of certain of their features, in particular, the contra-rotational nature of the input and output shafts being on the same axis. This invention optionally provides in a one-body transmission a more practical way of supporting the load from one side than known prior art it also can provide a continuously variable ratio from one input and can have this variable ratio controlled by a control means that does not necessarily rely on slippage and has the capabilities of being self-regulating.

The invention is capable of absorbing energy from the load connected too an output or supplying energy to an output, thus providing regenerative braking or acceleration according to an output power demand.

In one aspect the invention provides a variable speed transmission having at least one input and at least one output and being of the epicyclic type using toothed gearing or preferably cycloidal arrangements involving interaction of three mechanically distinct rotating elements, namely a sun element, a ring element and a planet carrier element in each of at least first and second unequal co-axial epicyclic assemblies, a first rotating element of the first assembly free to rotate and a first rotating element of the second assembly constrained to rotate at a controlled angular velocity relative to a fixed frame of reference, a second rotating element of the first assembly and a second rotating element of the second assembly being constrained to rotate at a common angular velocity, and control means for progressively changing the gear ratio applied to a load connected the first rotating element of the first assembly of the Variable Ratio Multi-gear characterised in that the first rotating elements are unequal pairs of the same mechanical elements of the respective assemblies and in conjunction with respective second rotating elements each represent different respective fixed gear ratios relative to the input and the output of the Variable Ratio Multi-gear, the second rotating elements are unequal pairs of the same mechanical elements of the respective assemblies and in conjunction with respective said first rotating elements each represent fixed gear ratios between the input and the output of the Variable Ratio Multi-gear, a third element of the second assembly rotating at a controlled angular velocity,the control means being operative to progressively increase or decrease the output gear ratio automatically in accordance with the demand.

In the description “output higher gear stage of operation” means “higher” in the sense of a gear ratio approaching 1:1 ratio as input to output, while “output low gear stage of operation” means an output gearing in the opposite sense generally corresponding to a lower output angular velocity.

The first rotating elements are typically the ring elements of the respective assemblies, The ring elements are preferably outer bodies having spaced endless scallop guides, each scallop guide having a relatively unequal number of scallops to rollers in either side depending on the required gear ratios for a particular application and the guides being adapted to receive sets of planet rollers of the planet carrier elements.

The second rotating elements are typically the planet carrier elements of the respective assemblies. The planet carrier elements are typically formed as an integral unit housing spaced sets of rollers with relatively unequal numbers relative to the number of scallops, with the rollers corresponding to the planets of each assembly, the rollers bridging between the scallop guides of the outer bodies and the third elements of the assemblies. The planet carrier is preferably constrained by a rotation blocking means to travel in one direction only. The rotation blocking means is preferably a selective rotation blocking means enabling selection of rotation of the second rotating elements in forward or reverse direction. The rotation blocking means may in some applications be allowed to rotate at a controlled angular velocity in the direction that it is blocking to enable a further reduced output low gear stage of operation.

The third elements of the assemblies are typically sun elements in the form of respective cams, with at least one cam and in practical terms both cams typically having a roller bearing or bush assembly separating the cam into an inner cam and a cam ring able to travel opposite the direction of the inner cam.

The control means can be any means that enables a variable rotation to be supplied to the third element of the second assembly across a continuous range of output gear ratios between zero and a speed that causes the planet carrier element angular velocity to equal the angular velocity of the third element of the first assembly.

Modules made up of the first and second assemblies can be employed in various arrangements with various inputs and outputs and connections between modules for various applications. What is common is that each of the first and second assemblies of each module share a common planet element, the first element of the first assembly is connected to the load directly or to another module and the first element of the second assembly has its angular velocity controlled relative to a fixed frame of reference which the angular velocity for some applications will be zero relative to a fixed frame of reference, the third element of the second assembly has its angular velocity controlled relative to the third element of the first assembly and may vary or not vary proportionally to the angular velocity of the third element of the first assembly, The control of the angular velocity of the first element of the second assembly relative to a fixed frame of reference can be done by a plethora of means including hydraulics with the displaced hydraulic fluid being directed so as to use the power in the fluid to add to the input power.

In practice for some applications there may need to be a braking system that connects the first element of the first assembly to the third element of the first assembly or directly to the input to stop an overrun situation where the input angular velocity to the third element of the first assembly has been reduced and the inertia of elements connected to the first element of the first assembly needs to be controlled.

### BRIEF DESCRIPTION OF THE DRAWING

FIG. 1 has been given as an illustrative example of the present invention and many variations and modifications thereto will be apparent to those skilled in the art without departing from the broad ambit and scope of the invention as herein set out in the appended claims. FIG. 1 is a variation indicated in the diagram previously labelled FIG. 4A. The variations of FIG. 4A were indicated by the element numbering system. The following table shows the correlation between the element numbers in FIG. 1 and those in the diagram previously labelled FIG. 4A.

| Element | Element | Description |
|---|---|---|
| 1 | 13 | Input shaft |
| 3a | 17 | Cam - Sun Element |
| 3b | 16 | Cam - Sun Element |
| 5b | 21 | Body (Output) - Ring Element (scallops are |
| | | indicated as 9 in Figure 4A) |
| 5c | 26 | Body - Ring Element (scallops are indicated as 9 |
| | | in Figure 4A) |
| 14 | 14 | Rotor |
| 15 | 15 | Rotor |
| D6 | 22 | Cage - Combined Carrier Element for |
| | | assemblies 11 and 12. |

### METHOD OF PERFORMANCE

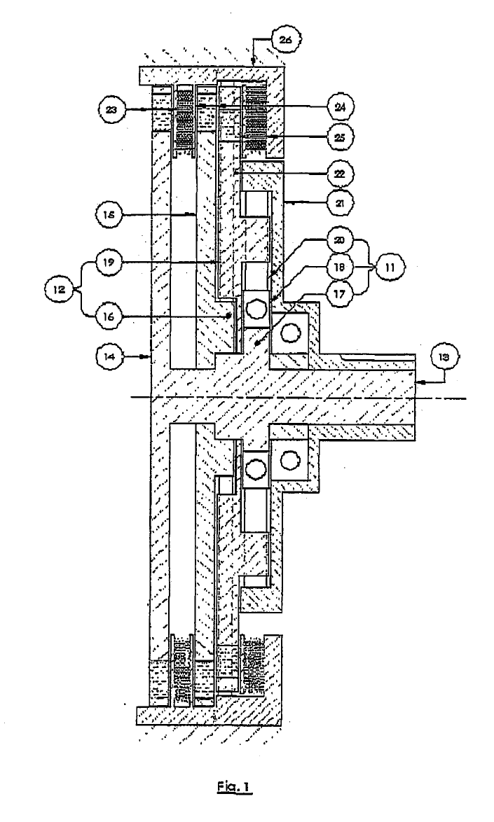

In the example illustrated in FIG. 1, the module employs first and second unequal co-axial epicyclic assemblies (11) and (12), these are both of the cycloidal type, that is, employing scallops and rollers.

Modules employed will vary in specific arrangement for other applications. What is common is that each of the assemblies (11) and (12) share a common planet element The sun elements are separate cams, rollers bridge between the cams and the scallops. The planet element comprises a planet carrier bridging axially between the assemblies having opposite sides which are relatively unequal in terms of the number of rollers to the number of scallops carried by the planet carrier, while the ring element comprises an outer body having scallops arranged so the assemblies each represent different fixed ratios relative to an input and an output.

This means the planet carriers of the two assemblies are constrained to rotate at the same angular velocity. In the illustrated embodiment the angular velocity of the output (21) could be zero.

In each assembly the cams are eccentric cams which rotate in co-operation with the scallops and roller configuration of the respective assemblies. One of the cams is driven by an input shaft, this will cause the output, that is the outer body, to rotate while the other cam rotates according to a variable ratio which may be connected to the same input as the other cam. The output gear ratio is influenced by the angular velocity of the second cam, thus various arrangements for applying a variable ratio to the second cam will influence the output in a controllable fashion according to demand.

While the above description deals with the general features involved, the following description will enable understanding of the application of the invention to the specific application of FIG. 1.

FIG. 1 shows a Variable Ratio Multi-gear multi-gear according to the invention an input, which is a rotor (14) an output (21) and electrical coil and permanent magnet arrangements (23-25) that apply torques respectively to rotors (14, 15) and a planet element in the form of a cage (22).

Items (23), (24) and (25) are arrangements of permanent magnets and electrical coils so that with electricity flowing through the coils, interacting magnetic fields are produced which cause a torque on the rotors (14), (15) and cage (22) respectively. The electricity supply can be adjusted individually for each of items (23) to (25) The electrical coil and permanent magnet arrangements (23-25) could be replaced by any type of motive sources and could be connected to the cams (16) and (17) in a plethora of ways.

The body (26) can be split at the dashed vertical dashed line (shown at the top and bottom of body (26)) and the left part of body (26) held relative to a fixed frame of reference and the right part being constrained to rotate about the same axis as cams (16) and (17) at a controlled angular velocity relative to the left part of body (26). The body (26) would be most likely split as described above in an arrangement where the input to cam (16) was constant or fixed at a constant ratio to the angular velocity of cam (17). In the following example the body (26) is not split and the whole of body (26) is held relative to a fixed frame of reference.

The rotor (14) and input shaft (13) are combined as an integrated part in this module. As an alterative, the rotor (14) could be removed and the input could be solely from an external motive source driving the input shaft (13). The point is the module comprising the groupings (11) and (12) remains the same.

Assembly (11) is the first unequal coaxial assembly and comprises of a cam {sun-element} (17), bearing (18) and rollers {planet-element} (20). The cam (17) is fixed to the input shaft (13), which is therefore fixed to the input. The bearing (18) has an inner sleeve fitted to the outer diameter of the cam (17). The bearing has an outer sleeve, the outer sleeve of the bearing (18) makes contact with the rollers (20). As the input rotates, the cam (17) causes the bearing (18) to move in an eccentric fashion. This causes the rollers (20) to be cyclically displaced away and towards the central axis of the Variable Ratio Multi-gear, the total displacement relative to this central axis, being twice the cam axis offset from this axis. The rollers (20) are located in equally spaced guides in the cage (planet element) (22). The rollers (20) make contact with scallops in the output {ring element}(21). For both assemblies (11 & 12), the number of scallops relative to the number rollers in contact with the scallops, determines the direction of rotation it would rotate the cage (22) if the body the rollers act against, bodies (21) and (26). were held still. One more scallop than the number of rollers gives a cage rotation direction the opposite to the cam rotation. One less scallop than the number of rollers would give a cage rotation the same as the cam rotation. The scallops are so shaped that as the rollers are acted on by the cam, the scallops rotate relative to the cage at a constant angular velocity ratio to that of the cam. The action between the cam (17), bearing (18) and rollers (20) against the output (21), causes an equal and opposite reaction on the cage (22), tending to rotate it in the opposite direction to the rotation of the output (21). The cage (22) is constrained by a rotation blocking means (not shown) in such a way as to allow the cage (22) to only rotate in a direction the same as the output (21) and optionally at a controlled angular velocity in the direction that it is blocking. Therefore because of the reactive forces, the cage (22) will be held against the rotation blocking means with just the actions of assembly (11) alone. The magnetic effects caused by items (25) can drive the cage (22) (with the same action as (23) does on item (14)). The torque caused by items (25) would need to be higher relative to the torque required at the cams (11) and (17) and so is an ancillary action and not necessary for the central concept of the present invention although it may be necessary for some applications to include it. The rollers will rotate about there own axis as they move in relation to the scallops. The bearing (18). is added to eliminate the sliding action of roller (20) against cam (17), which would occur (if they were in direct contact) because of the difference in the direction of there angular rotations. The output (21) is constrained to rotate about the central axis of the input shaft (13), The cyclical movement of the rollers (20) acting on the scallops alone, causes the output (21) to rotate at a reduced rotational speed depending on the number of rollers and scallops.

For example, if the cage (22) is constrained from being able to rotate, and if assembly 11 has four rollers (20), and there are five scallops in the output (21), the ratio would be one output (21) revolution for every five revolutions of the cam (17) with the output (21) rotating in the same direction as the cam (17). If the output (21) was held and the cage (22) free to rotate, the ratio would be one cage (22) rotation for every four of the cam (16) in the opposite direction of rotation to cam (16). The rotation blocking means discussed above would normally block this rotation although the direction that is blocked will have to be changed to allow reversing or other functions.

Assembly (12) is the second unequal coaxial assembly and comprises-of a cam (16), and rollers (19). The scallops in the output (21) make contact with the rollers (19) which make contact with the cam (16). The cam (16) is fixed to the rotor (15). The rotor (16) drives cam (16) through the action of the magnet and coil arrangement (24), A bearing could be optionally fitted to the outside diameter of the cam (16). The relative number of scallops and rollers for assembly (12) are different to the numbers for assembly (11). The rollers are located in equally spaced guides in the cage (22). The cage therefore bridges axially between assemblies (11) and (12) and the rollers (19) are constrained to rotate at the same angular velocity about the central axis of the input shaft (13) as the rollers (20) of assembly (11). The numbers of scallops and rollers are such that if the body (26) is constrained from being able to rotate, the action of the cam (16) against the rollers (19) and the consequential rollers (19) against the scallops in body (26) will cause the cage (22) to rotate in the same direction as the cams (16) and (17). The action of cam (17) therefore tries to rotate the cage (22) against the rotation blocking means and cam (16) tries to rotate the cage (22) away from the rotation blocking means.

For example, if the body (26) is constrained from being able to rotate, and the cage (22) free to rotate and if assembly (12) has four rollers (20), and there are three scallops in the body (26) the ratio would be one cage (22) revolution for every four revolutions of the cam (16), with the cage (22) rotating in the same direction as the cams (16) and (17). This is the same ratio that cam (17) would rotate the cage (22) if the output (21) is constrained from rotating, but in the opposite direction to the action of cam (16). Therefore with the same torque input to both cams (16) & (17) then the torque by cam (17) tending to hold the cage (22) against the rotation blocking means will be balanced by the torque by cam (16) tending to lift the cage (22) away from the rotation blocking means.

If the assembly (11) cam (17) is caused to rotate, the output (21) will rotate at another angular velocity, being a fixed ratio to the input angular velocity. The assembly (12) cam (16) will rotate at an angular velocity dependent on the input from the magnet and coil arrangement (24), and for the central concept of this arrangement, in the same direction to cam (17). The cam (16) will have no effect on the output angular velocity until the electrical coils of items (24) are activated. With the electrical coils activated, a torque is transmitted through the rotor (15) to the cam (16). The electrical coils could be activated so that the torque acts in the same or opposite direction as the rotation of the cam (17). The torque in this arrangement would act in the same direction as the rotation of the cam (17), the output (21 ) would rotate at the angular velocity determined by the fixed ratio but with an increased rotation dependent on the amount of rotation contributed by the action of items (24) on cam (16) (via the rotor (15)) onto the cage (22). It is the rotation of the cage (22) that causes the output to increase its angular velocity relative to the input angular velocity When the angular velocity of the cage (22) reaches the same angular velocity of cam (17) there is no relative difference in angular velocities between the two, therefore the output (21) will rotate at the same angular velocity as the input (13). Any angular velocity of the cage (22) between zero and the angular velocity of the input will give an angular velocity of the output (21) between a ratio determined by the fixed ratio of assembly (11) and the angular velocity of the input. If the arrangement shown in FIG. 1 is operating with the maximum possible power supply to the electrical coils and the input (13) is rotating at a constant angular velocity, then there would need to be a relative reduction in the output (21) resistive torque (hereafter called the ‘load’) before the coils of items (24) would be supplied power. With a reduction in load, the torque required by cam (17) reduces because of the fixed ratio of assembly (11). The power required by the coils of items (25) therefore is reduced. When the reduction in load is of a sufficient value that the power not used by the coils of items (25) can be used by the coils of items (24) to provide enough torque to cam (16) to rotate the cage (22) away from the rotation blocking means, then power is supplied to the coils of items (24). The output gear ratio therefore can be progressively decreased from the fixed ratio of the first assembly to a 1:1 ratio by progressively increasing the torque acting on the cam (16) from zero to a value that causes the cage (22) to rotate at the same speed as the input (13). The output torque is inversely proportional to the output angular velocity.

Whilst the above has been given by way of illustrative example of the present invention many variations and modifications thereto will be apparent to those skilled in the art without departing from the broad ambit and scope of the invention as herein set out in the appended claims.

1. A Variable Ratio Multi-gear having an input and an output and being of the epicyclic type involving interaction of three mechanically distinct rotating elements, namely a sun element, a ring element and a planet carrier element in each of at least first and second unequal coaxial epicyclic assemblies, a second rotating element of the first assembly and a second rotating element of the second assembly being constrained to rotate at a common angular velocity, and control means for progressively changing the gear ratio applied to a load connected to the first rotating element of the first assembly of the Variable Ratio Multi-gear characterised in that the first rotating elements are unequal pairs of the same mechanical elements of the respective assemblies and in conjunction with respective second rotating elements each represent different respective fixed gear ratios relative to the input and the output of the Variable Ratio Multi-gear, the second rotating elements are unequal pairs of the same mechanical elements of the respective assemblies and in conjunction with respective said first rotating elements each represent fixed gear ratios between the input and the output of the Variable Ratio Multi-gear, the control means being operative to progressively increase or decrease the output gear ratio in accordance with the demand for an output lower or higher gear stage of operation.

2. The Variable Ratio Multi-gear according to claim 1 wherein the first rotating elements are the ring elements of the respective assemblies, the ring elements being outer bodies having spaced endless scallop guides, each scallop guide having unequal numbers of scallops and the guides being adapted to receive sets of planet rollers of the planet carrier elements, the second rotating elements being planet carrier elements of the respective assemblies, the planet carrier elements housing spaced sets of rollers of unequal numbers of rollers corresponding to the planets of each assembly, the rollers bridging between the scallop guides of the outer bodies and the third elements of the assemblies, the planet carrier elements being constrained by a rotation blocking means allowing rotation in one direction and a controlled rotation in the other direction, the third elements of the assemblies being sun elements in the form of respective cams.

3. The Variable Ratio Multi-gear according to claim 1 wherein the first rotating elements are the ring elements of the respective assemblies, the ring elements being outer bodies having spaced endless scallop guides, each scallop guide having unequal numbers of scallops and the guides being adapted to receive sets of planet rollers of the planet carrier elements, the second rotating elements being planet carrier elements of the respective assemblies, the planet carrier elements housing spaced sets of rollers of unequal numbers of rollers corresponding to the planets of each assembly, the rollers bridging between the scallop guides of the outer bodies and the third elements of the assemblies, the planet carrier elements being constrained by a rotation blocking means allowing rotation in one direction and a controlled rotation in the other direction, the third elements of the assemblies being sun elements in the form of respective cams, the control means being operable to supply a variable rotation to the third element of the second assembly across a continuous range of output gear ratios between low and high angular velocities at respective predetermined low and high output angular velocities.

4. The Variable Ratio Multi-gear according to claim 1 wherein the first rotating elements are the ring elements of the respective assemblies, the ring elements being outer bodies having spaced endless scallop guides, each scallop guide having unequal numbers of scallops and the guides being adapted to receive sets of planet rollers of the planet carrier elements, the first rotating element of the second assembly constrained to a fixed frame of reference, the second rotating elements being planet carrier elements of the respective assemblies, the planet carrier elements housing spaced sets of rollers of unequal numbers of rollers corresponding to the planets of each assembly, the rollers bridging between the scallop guides of the outer bodies and the third elements of the assemblies, the planet carrier elements being constrained by a rotation blocking means allowing rotation in one direction and a controlled rotation in the other direction, the third elements of the assemblies being sun elements in the form of respective cams, a third element of the second assembly rotating at a controlled angular velocity the control means being operative to progressively increase or decrease the output gear ratio in accordance with the demand for an output lower or higher gear stage of operation.

5. The Variable Ratio Multi-gear according to claim 1 wherein the first rotating elements are the ring elements of the respective assemblies, the ring elements being outer bodies having spaced endless scallop guides, each scallop guide having unequal numbers of scallops and the guides being adapted to receive sets of planet rollers of the planet carrier elements, the second rotating elements being planet carrier elements of the respective assemblies, the planet carrier elements housing spaced sets of rollers of unequal numbers of rollers corresponding to the planets of each assembly, the rollers bridging between the scallop guides of the outer bodies and the third elements of the assemblies, the planet carrier elements being constrained by a rotation blocking means allowing rotation in one direction and a controlled rotation in the other direction, the third elements of the assemblies being sun elements in the form of respective cams, the third element of the second element assembly being constrained to rotate at a respective fixed gear ratio relative to an input to the Variable Ratio Multi-gear, the control means being operable to supply a variable rotation to the first element of the second assembly across a continuous range of output gear ratios between low and high angular velocities at respective predetermined low and high output angular velocities.
